(19) United States
(12) Patent Application Publication
(10) Pub. No.: US 2007/0250307 A1
(43) Pub. Date: Oct. 25, 2007

(54) SYSTEM, METHOD, AND COMPUTER READABLE MEDIUM THEREOF FOR LANGUAGE LEARNING AND DISPLAYING POSSIBLE TERMS

(75) Inventor: Hsu-Kuang Chao, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: IQ TECHNOLOGY INC., Taipei (TW)

(21) Appl. No.: 11/681,519

(22) Filed: Mar. 2, 2007

Related U.S. Application Data
(60) Provisional application No. 60/779,238, filed on Mar. 3, 2006.

(51) Int. Cl. G06F 17/27

(52) U.S. Cl. 704/9

(57) ABSTRACT

A language learning system, method, and computer readable medium thereof are provided. In this system, (1) the deciding module decides an original term, (2) the retrieving module retrieves a plurality of possible terms, and (3) the displaying apparatus displays the possible terms. Thereafter, the receiving interface receives an input option, wherein the input option comprises one possible term. The determining module determines whether the selected piece corresponds to the original piece. Lastly, the generating module generates a report according to the determined result. By providing various possible Chinese characters and Chinese phrases that challenge the user appropriately, the user can learn the language much more effectively.

This application claims the benefit of priority based on U.S. Ser. No. 60/779,238 filed on Mar. 3, 2006, the disclosures of which the contents are incorporated herein by reference in its entirety.

### CROSS REFERENCES TO RELATED APPLICATIONS

Not applicable

### BACKGROUND OF THE INVENTION

1. Field of the Invention

The invention relates to a system, a method, and a computer readable medium thereof for language learning and displaying possible terms; specifically, it relates to a system, a method, and a computer readable medium thereof for language learning and displaying possible terms using similar Chinese Pinyin and character structures to train a user.

2. Description of the Related Art

Language is important for human communication. Thus, multi-lingual capabilities are beneficial for individuals in an increasingly global world. Over recent decades, the Chinese language has piqued the interests of many non-Chinese speaking individuals.

While most language learning systems on the market today are for learning English, relatively fewer learning systems are for teaching other languages. As a result, the English language learning system digitizes conventional language learning styles. For example, most examination questions for listening, reading, and grammar are stored in the database, where the user is required to select suitable examination questions according to his or her language level. Nevertheless, this type of language learning system is only appropriate for user with a basic understanding of the language. That is, the user needs a basic understanding of the language to to be able to tackle these examination questions.

Unfortunately, the aforementioned English learning systems are not suitable for learning the Chinese language. The main reason is that there are too many similar Chinese characters, especially regarding character structure and Pinyin. Likewise, many Chinese phrases are similar to one another. Although these Chinese characters and phrases have similar character structures and Pinyin, their meanings are quite different. If the learner can not correctly recognize the character structure and Pinyin of the Chinese character and Chinese phrase, they will make mistakes.

Thus, based on the aforementioned concerns, it is important to provide a system that can train the user to recognize the character structure and Pinyin of Chinese characters and Chinese phrases, so that the user can properly learn the Chinese language.

### SUMMARY OF THE INVENTION

An objective of this invention is to provide a system for displaying possible terms. The system comprises a receiving module, a determining module, a retrieving module, and a display module. The receiving module is configured to receive an inputted term. The determining module is configured to determine whether a storage device comprises the inputted term. The retrieving module is configured to retrieve the possible term corresponding to the inputted term if the inputted term is in the storage device. The displaying module is configured to display the possible term. The inputted term can be a Chinese Pinyin, a Chinese character, or a Chinese phrase. Likewise, the possible term can be a corresponding character, a corresponding phrase, a Pinyin, a possible correct Pinyin, a possible correct term, and a definition thereof, etc. The method can then retrieve and display possible terms of the inputted term to aid in language learning.

Another objective of this invention is to provide a language learning system. The system comprises a deciding module, a retrieving module, a displaying apparatus, a receiving interface, a determining module, and a generating module. The deciding module is configured to decide an original term. The retrieving module is configured to retrieve a plurality of possible terms related to the original term. The displaying apparatus is configured to display the possible terms. The receiving interface is configured to receive an input option, wherein the input option selects one of the possible terms. The determining module is configured to determine whether the selected piece corresponds to the original piece. The generating module is configured to generate a report of the learning situation, according to the determined result.

Another objective of this invention is to provide a method for displaying a possible term. The method comprises the following steps: receiving an inputted term; determining whether a storage device comprises the inputted term; retrieving the possible term corresponding to the inputted term if the inputted term is in the storage device; and displaying the possible term. The inputted term can be a Chinese Pinyin, a Chinese character, or a Chinese phrase, while the possible term can be a corresponding character, a corresponding phrase, a Pinyin, a possible correct Pinyin, a possible correct term, or a definition thereof, etc. Since the method can retrieve and display the possible terms of the inputted term, the method can aid in language learning.

Another objective of this invention is to provide a language learning method. The method comprises the following steps: deciding an original term; retrieving a plurality of possible terms related to the original term; displaying the possible terms; receiving an input option, wherein the input option selects one of the possible terms; determining whether the selected piece corresponds to the original piece; and generating a report of the learning situation according to the determined results.

Yet a further objective of this invention is to provide a computer readable medium that stores a computer program for executing a method for displaying a possible term. The method is used for language learning. The method comprises the following steps: receiving an inputted term; determining whether a storage device comprises the inputted term; retrieving the possible term corresponding to the inputted term if the inputted term is in the storage device; and displaying the possible term.

Yet a further objective of this invention is to provide a computer readable medium that stores a computer program for executing a language learning method. The method comprises the following steps: deciding an original term; retrieving a plurality of possible terms related to the original term; displaying the possible terms; receiving an input option, wherein the input option selects one of the possible terms; determining whether the selected piece corresponds to the original piece; and generating a report of the learning situation according to the determined result.

The invention retrieves a plurality of possible terms related to an original term or an inputted term. The original term can be decided by the user's input, be built into the system, or be decided according to the inputted term. The original and input term can be a Chinese character, Chinese phrase, or a Chinese Pinyin. The possible terms can be Chinese characters, Chinese phrases, Chinese Pinyins, definitions, sentences related to the original or inputted term. Furthermore, the inputted term, the original term and the possible terms may be similar in Pinyin or in character structure. Hence, the invention can provide various information based on the original term to train the user. According to the aforementioned arrangements and steps, the invention provides various language learning environments.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic diagram of the first embodiment of the present invention;

FIG. 1B is a schematic diagram of the result of the first embodiment;

FIG. 2A is a schematic diagram of the second embodiment of the present invention;

FIG. 2B is a schematic diagram of a net structure of a Chinese character;

FIG. 3 is a schematic diagram of the third embodiment of the present invention; and

FIG. 4 is a flowchart of the fourth embodiment of the present invention.

### DESCRIPTION OF THE PREFERRED EMBODIMENT

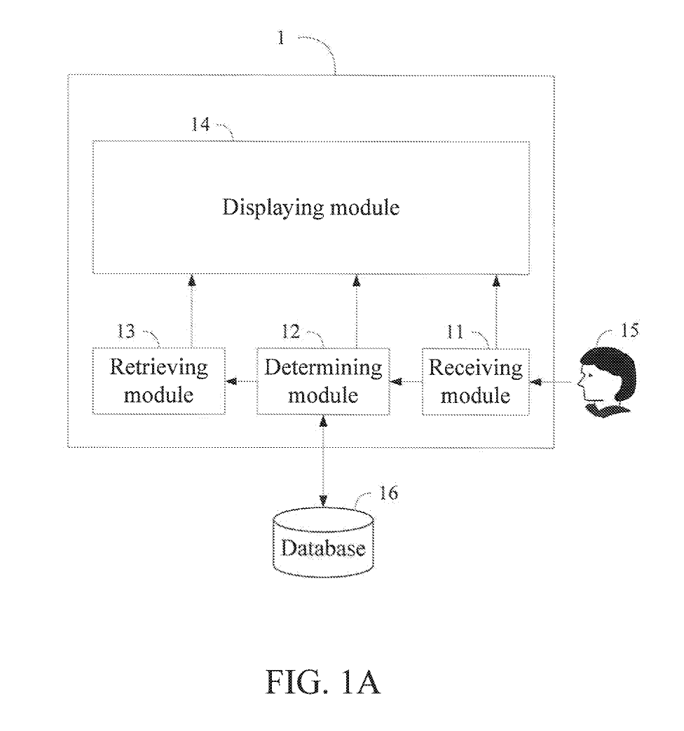

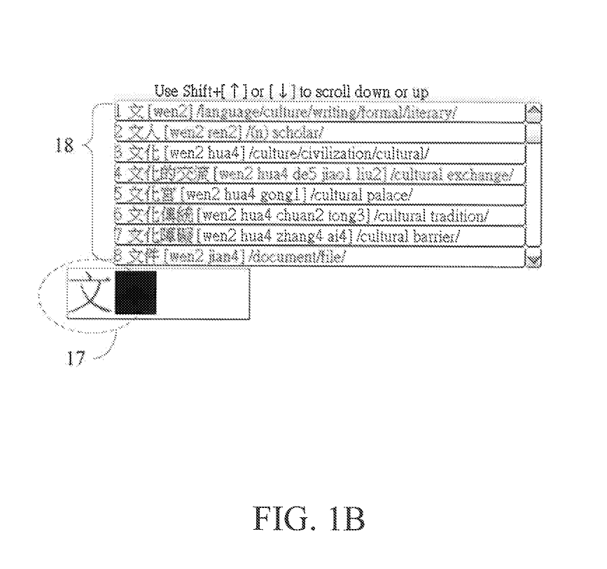

FIG. 1A illustrates a first embodiment of the present invention, which is a system for displaying possible terms. The system is used for language learning. The system 1 comprises a receiving module 11, a determining module 12, a retrieving module 13, and a displaying module 14.

The receiving module receives an inputted term from a user 15. For example, the inputted term entered by the user can be the Chinese character [symbol] which means “culture.” In other embodiments, the inputted term may be a Chinese Pinyin, a Chinese character, or a Chinese phase. Then, the determining module 12 determines whether a storage device 16 comprises the inputted term [symbol] . In the first embodiment, the determining module 12 determines that the storage device 16 comprises the inputted term [symbol] .

Then, the retrieving module 13 retrieves the possible terms corresponding to the inputted term [symbol] . In the first embodiment, the possible terms are the phrases and definitions related to the inputted term [symbol] . In other embodiments, the possible terms may be Chinese characters and phrases that are similar to the inputted term [symbol] in structure and/or in Pinyin.

Finally, the displaying module displays the inputted term [symbol] and the possible terms as illustrated in FIG. 1B. Specifically, the Chinese character in the circle 17 indicates the inputted term [symbol] , while the Chinese characters and phrases in the left bracket 18 indicate the possible terms of the inputted term [symbol] .

Based on the aforementioned arrangements, the system 1 is able to retrieve Chinese characters, Chinese phrases, and the corresponding definitions related to an inputted term. Consequently, the system 1 can be used as a language learning system.

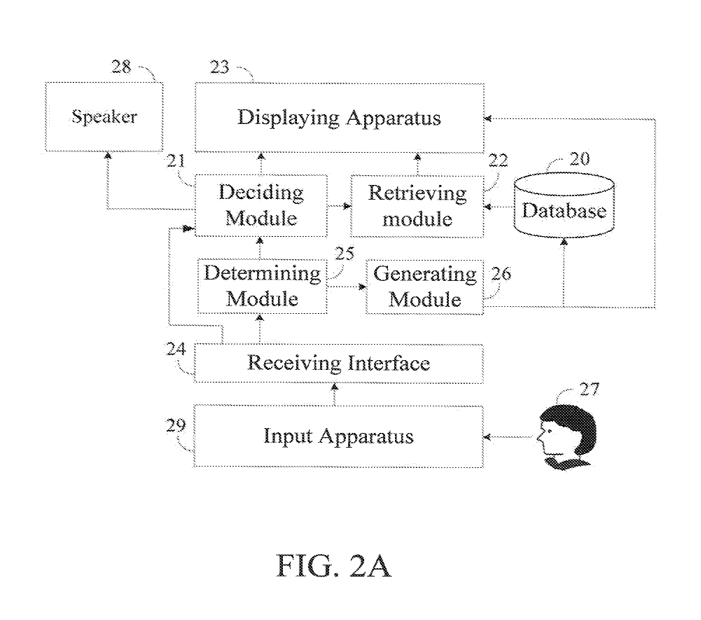

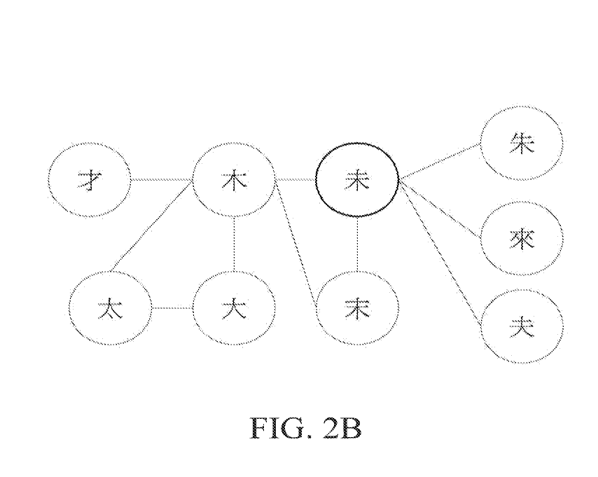

A second embodiment of the invention is shown in FIG. 2, which is a language learning system 2. The language learning system 2 comprises a deciding module 21, a retrieving module 22, a displaying apparatus 23, a receiving interface 24, a determining module 25, a generating module 26, a speaker 28, an input device 29, and a database 20. The displaying apparatus 23 can be a liquid crystal display (LCD), a cathode ray tube (CRT) display, or any hardware with displaying ability. The database 20 can be a floppy disk, a USB disk, a compact disk, a hard disk, or any hardware with storing ability. Each of the aforementioned modules can be implemented by an apparatus with operating ability.

After a user 27 starts the language learning system 2, the displaying apparatus 23 first displays a plurality of language learning levels, such as basic, intermediate, or high. After the user 27 selects one of the language learning levels through the input device 29, the receiving interface 24 receives the result of the selection made by the user 27. The deciding module 21 then decides the language learning level of the user 27, i.e. high level, according to the result of the mentioned selection. It is noted that language learning system 2 may decides the language learning level of the user 27 by providing more levels for the user 27 or dynamically adjusting the language learning levels according to a previous learning result (stored in the database 20). In other words, the way of determining the language learning level of the user 27 is not intended to limit the scope of this invention.

Thereafter, the language learning system 2 can immediately start to train the user 27 or provide a course menu of appropriate level courses for the user 27. Similarly, the user 27 can select the courses via the input apparatus 29. The receiving interface 24 would then receive the selection result of the user 27 to begin the training.

Assuming that the deciding module 21 expresses the sentence to be learned as [symbol] (which means, “he has not had a meal yet today”), the speaker 28 will then sound the phrase, [symbol] so that the user 27 can input data according to the sound. This embodiment assumes that the user 27 has correctly inputted the Hanyu Pinyins of the four Chinese characters [symbol] (i.e. he), [symbol] (i.e. today), [symbol] (i.e. day), and [symbol] (i.e. yet). In more details, the Hanyu Pinyin of [symbol] is “t a̅”, that of [symbol] is “j i̅n”, that of [symbol] is “ti a̅n”, and that of [symbol] is “shàng”. It is also assumed that the user has correctly select the corresponding four Chinese characters [symbol] after inputting the correct Hanyu Pinyins. It is also noted that the user may adopt other input methods, such as Tongyong Pinyin or Phonetic notation Pinyin.

Next, when processing the Chinese character [symbol] (i.e. has not), the user 27 inputs the Hanyu pinyin (i.e. inputted term), that corresponds to “wèi”. The receiving interface 24 receives the inputted Chinese Pinyin, i.e. the input Hanyu Pinyin of [symbol] so the determining module 25 can determine whether the input Hanyu Pinyin (wèi) is correct. In the second embodiment, the determining module 25 determines that the input Hanyu Pinyin is correct. In response, the deciding module 21 decides the original term to be [symbol] for the correct input Hanyu Pinyin (i.e. inputted term). The original term [symbol] is the Chinese character that the language learning system 2 will use to train the user 27. It is noted that the deciding module 21 does not need to wait until the determining module 25 has determined that the Hanyu Pinyin input is correct for it to decide the original term. The deciding module 21 may decide the following original term [symbol] immediately after processing the last Chinese character [symbol] . In other words, the deciding module 21 can decide the next Chinese character for training the user 27 at this stage.

After the deciding module 21 decides the original term as [symbol] the retrieving module 22 retrieves a plurality of possible terms, such as [symbol] (i.e. has not), [symbol] (i.e. end), [symbol] (i.e. wood), [symbol] (i.e. bright red), [symbol] (i.e. come), [symbol] (i.e. husband), [symbol] (i.e. just), [symbol] (i.e. large), and [symbol] (i.e. too) from the database 20, all of which are related to the original term according to the Language learning level of the user 27. Specifically speaking, as shown in FIG. 2B, a relation graph of the original term [symbol] is stored in the database 20. The nodes in the relation graph represent Chinese characters that have similar character structures to that of the original term [symbol] . Based on strokes, stroke orders, and radicals of Chinese characters, the relation graph is built by a statistics analysis tool or by artificial analysis by integrating Chinese characters that have similar structures to the Chinese character [symbol] . If the language learning level selected by the user 27 is basic or intermediate, the number of similar characters displayed on the displaying apparatus 23 is few. In addition, the displayed possible terms are more similar to the original term [symbol] .

The displaying apparatus 23 randomly displays nine possible terms, in any order, for example, [symbol] . If the original term [symbol] appears again, the displaying apparatus 23 will display nine possible terms in another order. The purpose of randomly displaying the nine possible terms is to prevent the user 27 from remembering the order of the possible terms. Hence, the user 27 is forced to remember the character structure of the original term [symbol] to maximize their learning.

Next, the user 27 utilizes the input device 29 to select one of the nine possible terms. This embodiment assumes that the user 27 selects (3) [symbol] as the input option, which is then received by the receiving interface 24. The determining module 25 determines whether the selected piece of possible data corresponds to the original term, that is, determining whether the input option, i.e. (3) [symbol] is the original term, i.e. the Chinese character [symbol] . The generating module 26 generates a report according to the determining result, whose content may comprise the previous training results. The training result may also include information such as the wrong frequency of every character and/or phrase, the thinking time of the user 27, etc. The generating module 26 may generate a grade according to the aforementioned information in the training result. For example, if the thinking time of the user 27 is shorter, the grade is higher. The result of the report can be displayed on the displaying apparatus 23 and/or be stored in the database 20.

The second embodiment of the invention represents the training content in other ways. For example, instead of being sounded by the speaker 28, the sentence [symbol] and the nine pieces of the possible data are directly displayed on the displaying apparatus 23. The aforementioned nine possible terms is retrieved according to the relation graph. The retrieving module 22 of the second embodiment may retrieve the pieces of the possible data from another relation graph based on Pinyin similarity. The second embodiment may also train the user 27 to recognize phrases. For example, if the training content was [symbol] , a possible option would be a character structure/Pinyin similar to the phrase [symbol] .

Based on the aforementioned arrangement, the second embodiment provides a language learning system of Chinese characters and phrases. During the training process, the system displays Chinese characters and phrases with similar character structures and/or Pinyin to enhance the user's ability to recognize similar Chinese characters and phrases.

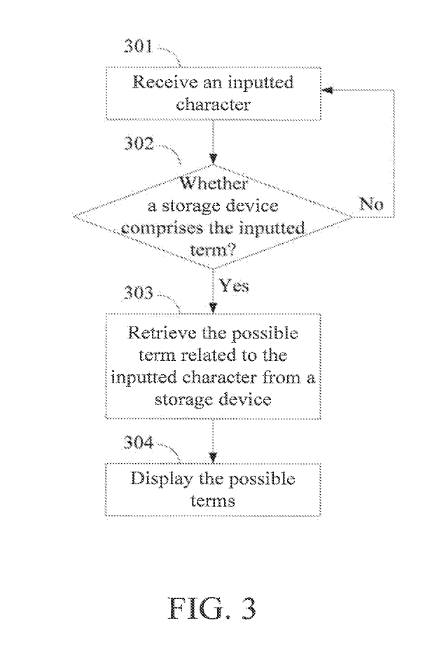

A third embodiment of the present invention is a method for displaying a possible term, whose flowchart is illustrated in FIG. 3. The method first executes step 301 to receive an inputted character. This embodiment assumes that the inputted character is the Chinese character [symbol] in the third embodiment. Then, step 302 is executed to determine whether a storage device comprises the inputted term. If not, the method returns to step 301. It step 302 detects the inputted term in the storage, step 303 is executed to retrieve the possible term from a storage device. Finally, step 304 is executed to display the possible terms.

In addition to the steps drawn in FIG. 3, the third embodiment can execute all the operations or functions mentioned in the first embodiment. People skilled in the art can directly understand how the third embodiment executes the operations and functions based on said first embodiment. Consequently, descriptions for the operations and functions are not repeated here.

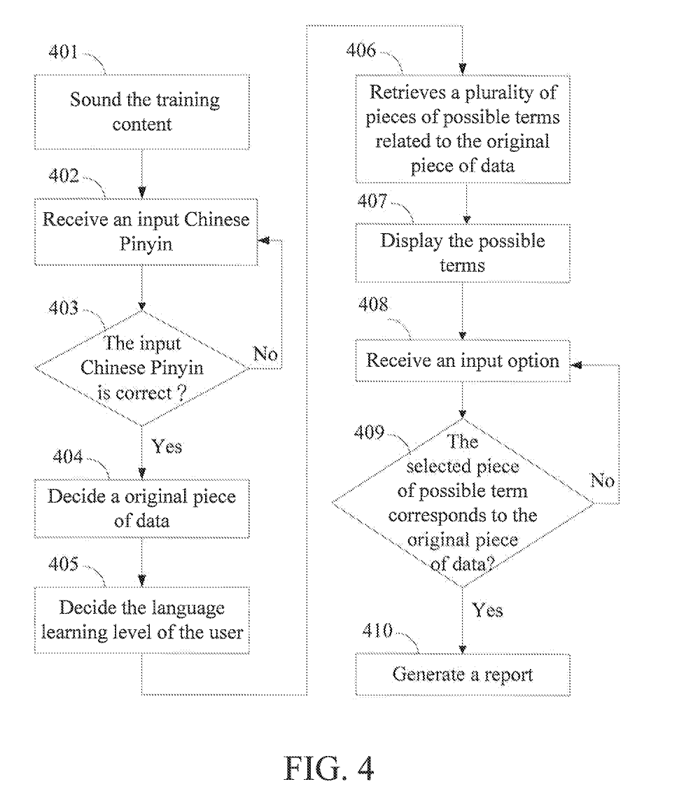

A fourth embodiment of the invention is shown in FIG. 4, which is a language learning method suitable for the language learning system 2 of the embodiment.

First, the deciding module 21 decides the training content, i.e. the sentence [symbol] . After that, the method executes step 401 to sound the phrase out through the speaker 28. This embodiment assumes that the user 27 has correctly inputted the Hanyu Pinyins of the four Chinese characters [symbol] . Next, the user 27 has to process the Chinese character [symbol] . This means that the user 27 has to input the Hanyu Pinyin (i.e. wèi) of the Chinese character [symbol] .

After that, step 402 is executed to enable the receiving interface 24 to receive an input Chinese Pinyin, i.e. an input of the Hanyu Pinyin of [symbol] . In step 403, the determining module 25 determines whether the input Chinese Pinyin (i.e. the input of the Hanyu Pinyin) is correct. If not, the method returns to step 402 to enable the receiving interface 24 to receive another Hanyu Pinyin input. If the input is correct, step 404 is enables the deciding module 21 to decide [symbol] as the original term.

Next, step 405 enables the deciding module 21 to decide the language learning level of the user 27 according to the previous learning result of the user 27. After that, step 406 enables the retrieving module 22 to retrieve a plurality of possible terms related to the original term [symbol] from the database 20 according to the language learning level of the user 27. Next, step 407 enables the displaying apparatus 23 to randomly display the possible terms, such as [symbol] .

The method then executes step 408 to enable the receiving interface 24 to receive an input option, wherein the input option selects one of the possible terms. In this embodiment, it is assumed that the user 27 selected (3) [symbol] as the input option for the receiving interface 24 to receive as the input option (3) [symbol] . In step 409, the method enables the determining module 25 to determine whether the selected piece of possible data (input option (3) [symbol] ) corresponds to the original term. If not, the method returns to step 408 to enable the receiving interface 24 to receive another input option. if the selected piece of possible data corresponds to the original term, step 410 enables the generating module 26 to generate a report according to the determined result.

In addition to the steps drawn in FIG. 4, the fourth embodiment can execute all the operations or functions mentioned in the second embodiment. People skilled in the art can directly understand how the second embodiment executes the operations and functions based on said first embodiment. Consequently, descriptions for the operations and functions are not repeated here.

The aforementioned method mentioned in the first and second embodiment can be used in application programs. The application programs can be carried on various computer readable medium, such as a floppy disk, a hard disk drive, an optical disc, a flash disk, a tape, a database accessible from a network or any storage medium with the same functionality that can be easily thought by people skilled in the art.

Furthermore, the invention provides possible terms related to the character structure and Pinyin of the Chinese character and phrase. Due to the use of these various possible terms, the invention provides various language learning environments.

The above disclosure is related to the detailed technical contents and inventive features thereof. People skilled in this field may proceed with a variety of modifications and replacements based on the disclosures and suggestions of the present invention as described without departing from the characteristics thereof. Nevertheless, although such modifications and replacements are not fully disclosed in the above descriptions, they have substantially been covered in the following claims as appended.

What is claimed is:

1. A system for displaying a possible term, comprising:
a receiving module for receiving an inputted term;
a determining module for determining a storage device comprising the inputted term;
a retrieving module for retrieving the possible term corresponding to the inputted term; and
a displaying module for displaying the possible term.

2. A language learning system, comprising:
a deciding module for deciding an original term;
a retrieving module for retrieving a plurality of pieces of possible data related to the original term;
a displaying apparatus for displaying the pieces of possible data;
a receiving interface for receiving an input option, wherein the input option selects one of the pieces of possible data;
a determining module for determining whether the selected piece of possible data corresponds to the original term; and
a generating module for generating a report according to the determining result, wherein the report shows a learning situation.

3. The system of claim 2, wherein the receiving interface further recieves an input Chinese Pinyin, the determining module further determines whether the input Chinese Pinyin is correct, and the deciding module decides the original term accordingly if the input Chinese Pinyin is correct.

4. The system of claim 2, wherein each of the original term and the pieces of possible data is a Chinese character.

5. The system of claim 4, wherein the retrieving module retrieves the pieces of possible data according to the Chinese Pinyin of the original term.

6. The system of claim 4, wherein the retrieving module retrieves the pieces of possible data according to the character structure of the original term.

7. The system of claim 2, wherein each of the original term and the pieces of possible data is a Chinese phrase.

8. The system of claim 7, wherein the retrieving module retrieves the pieces of possible data according to a Chinese Pinyin of the original term.

9. The system of claim 7, wherein the retrieving module retrieves the pieces of possible data according to a character structure of the original term.

10. The system of claim 2, wherein the displaying apparatus arranges the pieces of possible data randomly.

11. The system of claim 2, wherein the determining module further determines a language learning level of a user and the retrieving module retrieves the pieces of possible data according to the language learning level.

12. A method for displaying a possible term, comprising the steps of:
receiving an inputted term;
determining whether a storage device comprises the inputted term;
retrieving the possible term corresponding to the inputted term if the inputted term is determined in the storage device; and
displaying the possible term.

13. A language learning method, comprising the steps of:
deciding an original term;
retrieving a plurality of pieces of possible data related to the original term;
displaying the pieces of possible data;
receiving an input option, wherein the input option selects one of the pieces of possible data;
determining whether the selected piece corresponds to the original term; and
generating a report according to the determining result, wherein the report shows a learning situation.

14. The method of claim 13, further comprising the following steps:
receiving an input Chinese Pinyin; and
determining whether the input Chinese Pinyin is correct,
wherein the deciding step is executed if the input Chinese Pinyin is correct.

15. The method of claim 13, wherein each of the original term and the pieces of possible data is a Chinese character.

16. The method of claim 15, wherein the retrieving step retrieves the pieces of possible data according to a Chinese Pinyin of the original term.

17. The method of claim 15, wherein the retrieving step retrieves the pieces of possible data according to a character structure of the original term.

18. The method of claim 13, wherein each of the original term and the pieces of possible data is a Chinese phrase.

19. The method of claim 18, wherein the retrieving step retrieves the pieces of possible data according to a Chinese Pinyin of the original term.

20. The method of claim 18, wherein the retrieving step retrieves the pieces of possible data according to a character structure of the original term.

21. The method of claim 13, wherein the displaying step arranges the pieces of possible data randomly.

22. The method of claim 13, further comprising the step of determining a language learning level of a user, wherein the retrieving step retrieves the pieces of possible data according to the language learning level.

23. A computer readable medium storing a computer program to execute a method for displaying a possible term, comprising the steps of:
receiving an inputted term;
determining whether a storage device comprises the inputted term;
retrieving the possible term corresponding to the inputted term if the inputted term is determined in the storage device; and
displaying the possible term.

24. A computer readable medium storing a computer program to execute a language learning method, the method comprising the following steps:
deciding an original term;
retrieving a plurality of pieces of possible data related to the original term;
displaying the pieces of possible data;
receiving an input option, wherein the input option selects one of the pieces of possible data;
determining whether the selected piece corresponds to the original term; and
generating a report according to determining result, wherein the report shows a learning situation.

25. The computer readable medium of claim 24, further comprising the following steps:
receiving an input Chinese Pinyin; and
determining whether the input Chinese Pinyin is correct;
wherein the deciding step is executed if the input Chinese Pinyin is correct.

26. The computer readable medium of claim 24, wherein each of the original term and the pieces of possible data is a Chinese character.

27. The computer readable medium of claim 26, wherein the retrieving step retrieves the pieces of possible data according to a Chinese Pinyin of the original term.

28. The computer readable medium of claim 26, wherein the retrieving step retrieves the pieces of possible data according to a character structure of the original term.

29. The computer readable medium of claim 24, wherein each of the original term and the pieces of possible data is a Chinese phrase.

30. The computer readable medium of claim 29, wherein the retrieving step retrieves the pieces of possible data according to a Chinese Pinyin of the original term.

31. The computer readable medium of claim 29, wherein the retrieving step retrieves the pieces of possible data according to a character structure of the original term.

32. The computer readable medium of claim 24, wherein the displaying step arranges the pieces of possible data randomly.

33. The computer readable medium of claim 24, further comprising the step of determining a language learning level of a user, wherein the retrieving step retrieves the pieces of possible data according to the language learning level.
